(19) United States
(12) Patent Application Publication
(10) Pub. No.: US 2005/0232422 A1
(43) Pub. Date: Oct. 20, 2005

(54) GSM (Global System for Mobile communication) handset with carrier independent personal encryption

(76) Inventors: Jingdong Lin, Irvine, CA (US); Yan Zhang, Nanjing (CN); Datong Chen, Fremont, CA (US)

Correspondence Address: PERKINS COIE LLP;PATENT-SEA, P.O. BOX 1247, SEATTLE, WA, 98111-1247, US

(21) Appl. No.: 10/827,609

(22) Filed: Apr. 19, 2004

(51) Int. Cl. H04K 1/00

(52) U.S. Cl. 380/255

(57) ABSTRACT

The present disclosure introduces simple methods and systems for personal encryption of messages and data, using a GSM handset. The proposed methods and systems furnish another layer of communication security instead of or in addition to that of the carrier. Users can generate and customize their own encrypted communication, independent of the carrier. In one embodiment the existing handset hardware can be used to implement the personal encryption, without the need for additional hardware. The present disclosure also provides methods and systems for generating different encryption keys and synchronization methods. In one exemplary system the encryption key is kept in the memory of the handset, while in another exemplary system the key is downloaded from an SMS (Short Message Service) station. In one exemplary method the encryption key sequence is as long as the block data and is synchronized with each block data, while in another exemplary method the transmitted information is segmented and flagged for synchronization with the encryption key.

### TECHNICAL FIELD

The invention relates to the field of telecommunications, and, more particularly, to cryptographic methods and devices intended to encrypt messages (data).

### BACKGROUND

In North America wireless cellular telephony uses a time divisional multiple access (TDMA) communication protocol—a voice signal in either traffic direction—base station to mobile station or mobile station to base station. It is a sequence of digitized speech frames or blocks of a predetermined number of binary digits, representing the output of a speech-compressing analog-to-digital converter, together with various binary check digits and coding bits used for error detection and error correction. Since such systems operate over a wireless link, there is a risk of unauthorized interception of calls.

To provide privacy, a transmitting station using a conventional encryption technique forms a privacy mask, having the same predetermined number of binary digits as the speech frame, and encrypts each frame with this particular privacy mask, typically by combining the speech frame and the privacy mask using a bit-by-bit exclusive-OR (XOR) operation.

Decryption is performed at the receiving station, again by XORing the received speech frame and the privacy mask. This is because double XORing of a binary digit with the same binary bit value recovers its initial value.

An advantage of this conventional technique is that the transmitting station and receiving station each have a procedure for privately generating the privacy mask, so that the mask is neither transmitted nor directly available to eavesdroppers. Available computing systems have difficulty decrypting encrypted messages in real time.

An example of a wireless protocol is the Global System for Mobile Communication (GSM), which includes an optional encryption scheme. In this scheme, a database known as the Authentication Center holds an individual encryption key number, Kᵢ, for each subscriber, which is also stored on a chip known as the Subscriber Information Module held in the subscriber's mobile terminal. The subscriber has no access to the key.

When a secure session is requested, a random number is generated by the Authentication Center and used, together with the customer's key, Kᵢ, to calculate an encryption key, K_{c}, used during the session for encrypting and decrypting messages to/from the subscriber. The random number is sent from the Authentication Center to the subscriber's mobile terminal via the Base Transceiver Station. The mobile terminal passes the random number to the Subscriber Information Module, which calculates the encryption key K_{c} using an algorithm called A5, from the received random number and the stored key Kᵢ. Thus, the random number is sent over the air, but not the customer's key Kᵢ or the encryption key K_{c}.

The random number and the encryption key K_{c} are entered into the Home Location Register database of the GSM network, which stores details for the subscriber concerned. They are also sent to the Visiting Location Register for the area where the user terminal is currently located, and are supplied to the Base Transceiver Station by which the mobile station is communicating to the network.

The encryption key K_{c} is used, together with the current TDMA frame number, to implement the A5 algorithm in both the mobile terminal and the Base Transceiver Station so that data transmitted over the air interface between the mobile terminal and the Base Transceiver Station is encrypted. Thus, the individual user key Kᵢ is stored only at the Authentication Center and the Subscriber Information Module, where the encryption key K_{c} is calculated and forwarded to the Base Transceiver Station and the mobile terminal.

With new monitoring devices on the market, which make it easy to listen to and record speech and Short Message Service (SMS) communication of any given GSM cell phone number, there is a need for a personal encrypting option in cases where the users choose to enhance the communication security provided by the carrier or when the carrier disables its encryption algorithms. With the proposed system any two users can agree on mutual secret codes to privately encrypt their communications.

### BRIEF DESCRIPTION OF THE DRAWINGS

The foregoing aspects and many of the attendant advantages of the invention will become more readily appreciated as the same become better understood by reference to the following detailed description, when taken in conjunction with the accompanying drawings, wherein:

FIG. 1 is a functional block diagram of a typical GSM.

FIG. 2 is a functional block diagram of a personal encrypting method and system, in accordance with an embodiment of the present invention.

FIG. 3 is a flow diagram of a personal encrypting method, in accordance with an embodiment of the present invention.

### DETAILED DESCRIPTION

The present invention relates to methods and systems for personal encryption of messages and data, independent of the carrier, using a GSM handset. The proposed methods and systems furnish another layer of communication security in addition to that of the carrier, or provides the user with communication security in cases where the carrier has disabled its encryption algorithm. In the following description, several specific details are presented to provide a thorough understanding of the embodiments of the invention. One skilled in the relevant art will recognize, however, that the invention can be practiced without one or more of the specific details, or in combination with or with other components, etc. In other instances, well-known implementations or operations are not shown or described in detail to avoid obscuring aspects of various embodiments of the invention.

Reference throughout the specification to “one embodiment” or “an embodiment” means that a particular feature, structure, implementation, or characteristic described in connection with the embodiment is included in at least one embodiment of the present invention. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

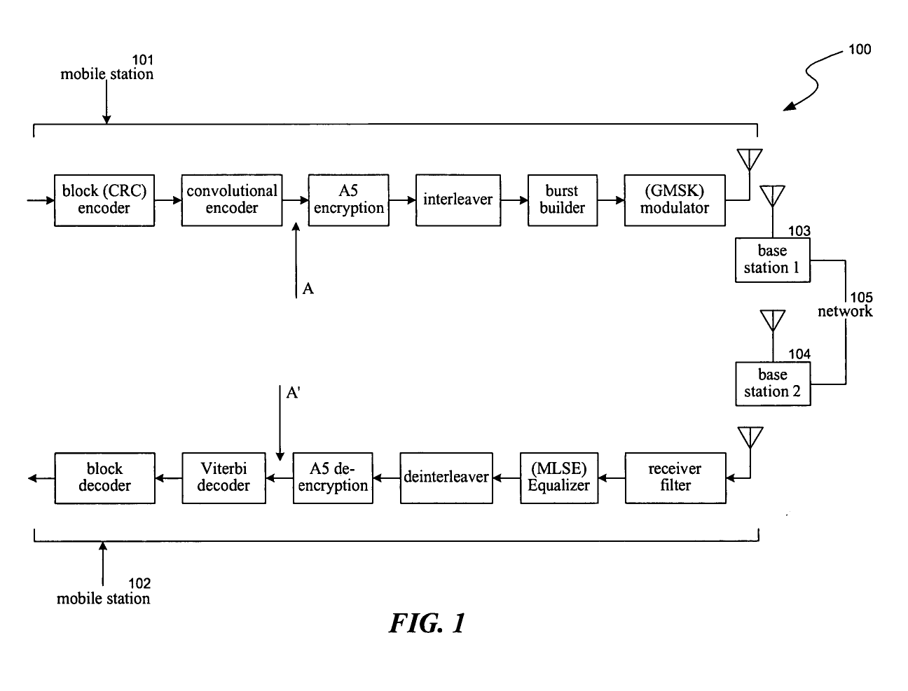

FIG. 1 is a functional block diagram of a typical GSM SYSTEM. The communication system 100 includes the transmitting and receiving mobile stations 101 and 102, respectively, the base stations 103 and 104, and the network 105. The transmitting mobile station 101 can be further divided into a block encoder, a convolutional encoder, an A5 encryption module, an interleaver, a burst builder, and a modulator. Likewise, the mobile station 102 can be divided into a receiver filter, an equalizer, a deinterleaver, an A5 decryption module, a Viterbi decoder, and a block decoder. The A5 encryption and decryption are applied to block data of, for example, 456 bits.

Traditionally, as mentioned above, the calculations for the privacy mask generation, or the encrypting and decrypting key generation, are initiated by transmission of a random number from the Authentication Center. Only this random number is transmitted over the air. Keys are generated locally, using this random number and a customer-specific key. Among other advantages, the present invention enables the user to enter his or her own random number, or private code, and initiate the key generation and the subsequent encryption, independent of the Authentication Center and its encryption algorithms. If the party receiving the call also enters the same random number, or private code, the two users can communicate using their own personalized and private encrypted messages and data.

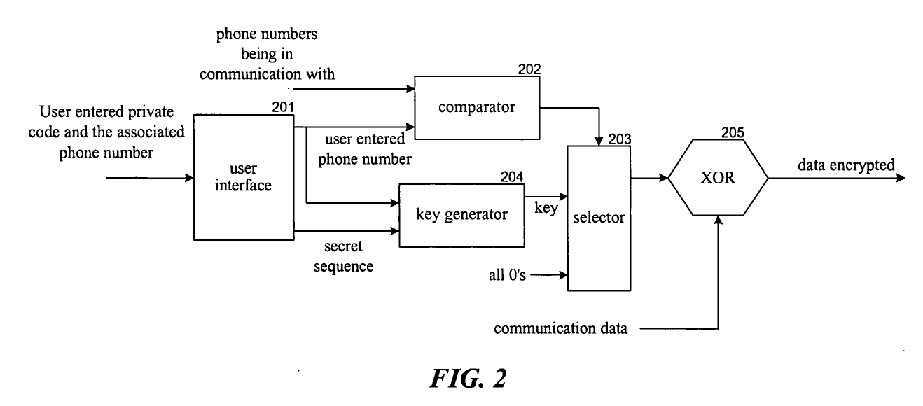

FIG. 2 is a functional block diagram of a personal encrypting method and system, in accordance with an embodiment of the present invention. In this embodiment, using a special entry in the cell phone menu, a user can enter any self-created secret code such as a string of numbers, letters, or a combination, into a user interface 201, along with the phone number for which the user intends to encrypt the communication. In one embodiment the user's secret code can be mapped into 5- to 8-bit binary sequences by commercially available mappings like ASCII or GB, or it can be mapped through a customized mapping scheme. Different methods, such as truncation or repetition, can be devised to take care of, respectively, secret codes that are too long or too short.

The user interface 201 passes the phone number part of an input to a comparator 202 to be compared with the phone number of the party in communication with, so that if there is a match, the communication will be encrypted. The comparator 202 generates and sends an enable signal to a selector module 203 if there is a match. The user interface 201 also passes the secret code part of the input to a key generator 204 to be used for the generation of encryption keys. In another embodiment the specified phone number may also be used along with the secret code to generate the encryption keys. In this way the same secret code generates different keys for different phone numbers.

If the comparator 202 sends an enable signal to the selector module 203, the encryption key will be provided to an XOR unit 205, and will be utilized to encrypt the message or data, block by block. But if the comparator 202 does not send an enable signal to the selector module 203, the selector module will continue to pass a string of 0's to the XOR unit 205 which results in the communication message or data passing through the XOR unit 205 without any alteration.

Unlike the existing methods in which the synchronization of the key and the transmitted data is between the mobile station and the base station, the present invention requires synchronization between the two mobile stations. This is because the encryption is applied to the two end users, or the two mobile stations, instead of one mobile station and one base station. For this reason the same method of synchronization employed by the A5 algorithm is not suitable for the proposed methods. In one embodiment, additional protocols may be added to transmit the frame number from one mobile station to the other mobile station. In another embodiment the key sequence may be as long as a data block and synchronization can be performed frame by frame.

Embodiments of the present invention do not necessitate extra hardware, although one of ordinary skill in the art will realize that functions such as key generation can be achieved with or without additional hardware. For example, the key sequence may either reside in the mobile station's existing memory or use pre-burned EPROMs or other memory devices, which are sold in pairs. Users may even download key sequences from SMS centers.

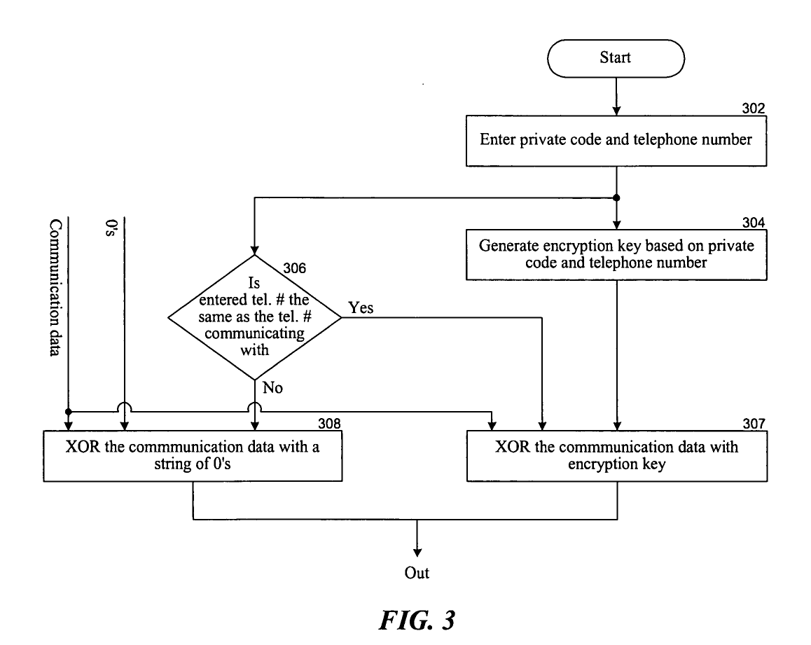

FIG. 3 is a flow diagram of a personal encrypting method, in accordance with an embodiment of the present invention. At step 302 the user enters his or her private secret code and the telephone number for which he or she desires to have the communication encrypted. At step 304 the encryption key generator, using the private code and the desired telephone number, generates an encryption key. At step 306 the desired telephone number is compared with the telephone number in communication with. If they are the same, step 307 is enabled to encrypt and decrypt the two-way communication by XORing the communication data with the generated encryption key. Note that the user in communication with should use the same private code or a private code which invokes or generates the same encryption and decryption keys as the other user's to allow two way communication.

But if the desired telephone number is not the same as the telephone number in communication with, in step 308 the communication data will not be altered since the data will be only XORed with a string of 0's. The embodiments of the present invention may be added to different points along the path of the communication system 100, such as points A and A′ depicted in FIG. 1.

The preferred and several alternate embodiments have thus been described. After reading the foregoing specification, one of ordinary skill will be able to effect various changes, alterations, combinations, and substitutions of equivalents without departing from the broad concepts disclosed. It is therefore intended that the scope of the letters patent granted hereon be limited only by the definitions contained in the appended claims and equivalents thereof, and not by limitations of the embodiments described herein.

1. A method of generating personal encryption for telephony, the method comprising:
entering a private code;
entering a telephone number;
generating encryption and decryption key sequences based on the entered information;
encrypting the outgoing information if in communication with the entered telephone number; and
decrypting the incoming information if in communication with the entered telephone number.

2. The method of claim 1, wherein the key generation is based on the entered private code.

3. The method of claim 1, wherein the key generation is based on the entered telephone number.

4. The method of claim 1, wherein the key generation is based on the entered private code and the entered telephone number.

5. The method of claim 1, wherein the generated key sequence for encryption is the same as the key sequence for decryption.

6. The method of claim 1, wherein the generated key sequence for encryption is different from the key sequence for decryption.

7. The method of claim 1, wherein the private code is any string of letters, numbers, symbols, or a combination thereof.

8. The method of claim 1, wherein the key sequence is a string of 0's.

9. The method of claim 1, wherein the key sequences reside in the memory of the mobile stations.

10. The method of claim 1, wherein the key sequences reside in EPROMs.

11. The method of claim 1, wherein the key sequences reside in any memory device.

12. The method of claim 1, wherein the key sequences are downloaded from SMS (Short Message Service) stations.

13. The method of claim 1, wherein the key sequences are as long as data blocks.

14. The method of claim 1, wherein the key sequences are longer or shorter than data blocks.

15. The method of claim 1, wherein the key sequences are as long as data blocks and are synchronized with data blocks.

16. The method of claim 1, wherein the key sequences are synchronized with flags or signals added to the transmitted information.

17. A method of generating personal encryption for telephony, independent of the carrier, using a handset, the method comprising:
entering a private code;
entering a telephone number;
generating encryption and decryption key sequences based on the entered information;
checking the telephone number communicating with;
encrypting the outgoing information, if the entered telephone number is the same as the telephone number being in communication with; and
decrypting the incoming information, if the entered telephone number is the same as the telephone number being in communication with.

18. The method of claim 17, wherein the key generation is based on the entered private code.

19. The method of claim 17, wherein the key generation is based on the entered telephone number.

20. The method of claim 17, wherein the key generation is based on the entered private code and the entered telephone number.

21. The method of claim 17, wherein the generated key sequence for encryption is the same as the key sequence for decryption.

22. The method of claim 17, wherein the generated key sequence for encryption is different from the key sequence for decryption.

23. The method of claim 17, wherein the private code is any string of letters, numbers, symbols, or a combination thereof.

24. The method of claim 17, wherein the key sequences reside in the memory of the mobile stations.

25. The method of claim 17, wherein the key sequences reside in at least one EPROM.

26. The method of claim 17, wherein the key sequences reside in at least one memory device.

27. The method of claim 17, wherein the key sequences are downloaded from SMS (Short Message Service) stations.

28. The method of claim 17, wherein the key sequences are as long as data blocks.

29. The method of claim 17, wherein the key sequences are longer or shorter than data blocks.

30. The method of claim 17, wherein the key sequences are as long as data blocks and are synchronized with data blocks.

31. The method of claim 17, wherein the key sequences are synchronized with flags or signals added to the transmitted information.

32. A method of generating personal encryption by Global System for Mobile Communication handsets, the method comprising:
entering a private code;
entering a telephone number;
generating encryption and decryption key sequences based on the entered private code, the entered telephone number, or both;
checking the telephone number communicating with;
encrypting the outgoing information with the generated encryption key, if the entered telephone number is the same as the telephone number being in communication with;
decrypting the incoming information with the generated decryption key, if the entered telephone number is the same as the telephone number being in communication with;
encrypting the outgoing information with a key sequence of all 0's, if the entered telephone number is not the same as the telephone number being in communication with; and
decrypting the incoming information with a key sequence of all 0's, if the entered telephone number is not the same as the telephone number being in communication with.

33. The method of claim 32, wherein the generated key sequence for encryption is the same as the key sequence for decryption.

34. The method of claim 32, wherein the generated key sequence for encryption is different from the key sequence for decryption.

35. The method of claim 32, wherein the private code is any string of letters, numbers, symbols, or a combination thereof.

36. The method of claim 32, wherein the key sequences reside in the memory of the mobile stations.

37. The method of claim 32, wherein the key sequences reside in at least one EPROM.

38. The method of claim 32, wherein the key sequences reside in at least one memory device.

39. The method of claim 32, wherein the key sequences are downloaded from SMS (Short Message Service) stations.

40. The method of claim 32, wherein the key sequences are as long as data blocks.

41. The method of claim 32, wherein the key sequences are longer or shorter than data blocks.

42. The method of claim 32, wherein the key sequences are as long as data blocks and are synchronized with data blocks.

43. The method of claim 32, wherein the key sequences are synchronized with flags or signals added to the transmitted information.

44. A system for generating personal encryption for telephony, the system comprising:
a user interface;
an encryption and decryption key sequence generator;
a telephone number comparator;
a key sequence selector;
an exclusive-OR functional module; and
an arrangement in which:
the user enters a private code and a telephone number into the user interface;
the comparator receives the telephone number being in communication with and receives the entered telephone number from the user interface;
the key sequence generator receives the private code and the entered telephone number from the user interface and generates encryption and decryption sequences based on the private code, the telephone number, or both;
the key sequence selector receives the generated keys of the key generator, a string of 0's, and the comparison result of the comparator; and
the exclusive-OR functional module receives the output of the selector, which is the generated key sequence if the comparator's inputs are the same, or the string of 0's if the comparator's inputs are not the same.
